(19) United States
(12) Patent Application Publication
(10) Pub. No.: US 2017/0223806 A1
(43) Pub. Date: Aug. 3, 2017

(54) SIGNAL CARRIER FOR CONTACTLESS LIGHTING SYSTEM AND LIGHTING SYSTEM INCLUDING A SIGNAL CARRIER

(71) Applicant: PHILIPS LIGHTING HOLDING B.V., EINDHOVEN (NL)

(72) Inventors: DIRK FIEBERT, GROTON, MA (US); ZACHARY ROBERT WESSNER, SALEM, NH (US)

(21) Appl. No.: 15/328,224

(22) PCT Filed: Jul. 10, 2015
(86) PCT No.: PCT/IB2015/055215

§ 371 Date: Jan. 23, 2017

Related U.S. Application Data
(60) Provisional application No. 62/027,301, filed on Jul. 22, 2014.

(51) Int. Cl. H05B 37/02; H01B 17/58; H02G 3/04; H04B 3/56

(52) U.S. Cl. CPC H05B 37/0263; H04B 3/56; H01B 17/58; H02G 3/0462; H02G 3/0443

(57) ABSTRACT

A lighting system includes at least one lighting component and a signal carrier. The signal carrier includes an electrically insulative webbing, and a first electrical conductor and a second electrical conductor separated and spaced apart from each other by the electrically insulative webbing and extending in parallel to each other in a longitudinal direction. The first and second electrical conductors are disposed at least partially within the electrically insulative webbing. The at least one lighting component is mounted to the signal carrier via a slot passing through the electrically insulative webbing, wherein the at least one lighting component includes at least one light source and at least one coupler configured to extract power from the first and second electrical conductors without making an electrically conductive physical contact to the first and second electrical conductors.

### TECHNICAL FIELD

The present invention is directed generally to a lighting system and a signal carrier for a lighting system. More particularly, various inventive systems and apparatus disclosed herein relate to a signal carrier for a controllable inductive lighting system and a lighting system which includes such a signal carrier.

### BACKGROUND

Digital lighting technologies, i.e. illumination based on semiconductor light sources, such as light-emitting diodes (LEDs), offer a viable alternative to traditional fluorescent, HID, and incandescent lamps. Functional advantages and benefits of LEDs include high energy conversion and optical efficiency, durability, lower operating costs, and many others. Recent advances in LED technology have provided efficient and robust full-spectrum lighting sources that enable a variety of lighting effects in many applications. Some of the fixtures embodying these sources feature a lighting module, including one or more LEDs capable of producing different colors, e.g. red, green, and blue, as well as a processor for independently controlling the output of the LEDs in order to generate a variety of colors and color-changing lighting effects, for example, as discussed in detail in U.S. Pat. Nos. 6,016,038 and 6,211,626, incorporated herein by reference.

Lighting systems such as digital lighting networks have been developed which include a plurality of lighting fixtures, each of which includes one or more LED light sources, all of which may be connected to a common electrical power line or lines and/or shared data line(s). Some lighting networks may also include other lighting network components, such as lighting sensors.

In most lighting networks, each lighting network component (e.g., lighting fixture) includes a basic electrical power and data interface that relies on a connector system which employs a physical metal-to-metal contact between the network component and the network cable(s) or wire(s). For example, some known lighting fixtures employ an insulation displacement contact (IDC) which allows the lighting fixture to be quickly and easily electrically connected to the cable(s) or wire(s) of a lighting network at virtually any desired location.

However, lighting fixtures which employ electrically conductive physical contacts to receive electrical power and communicate data from the cable(s) or wire(s) of a lighting network, and lighting networks in which such lighting fixtures are deployed, are prone to performance degradation and failure due to wear and damage to the electrically conductive physical contacts. Such wear or damage may occur, for example, when the contacts are exposed to contaminants such as moisture, or operate in suboptimal connection conditions. As a result, these electrical contacts sometimes require careful treatment and/or special design considerations to make them more reliable. Furthermore, in some cases lighting system components are inserted or connected to lighting system cabling over and over again, for example when they are moved from one lighting system to another, or when a lighting system is reinstalled, reconfigured, etc. In that case, performance degradation or failure may occur because the electrical contacts themselves also generally have a limitation or specification on the maximum number of times they can be inserted or connected.

Additionally, when two electrical conductors are provided for electrical power, and optionally data distribution, to one or more lighting network components via a split cord or cable, bare metal (e.g., copper) of one or both of the conductors carrying a live current may be exposed when the two wires are separated or split apart at the place(s) where the lighting network component(s) is/are located. Factory-split cable or cord with the two wires split apart at predetermined positions could be manufactured, but this does not offer any flexibility to the end user as far as where lighting network components (e.g., lighting fixtures) may be positioned to be connected to the cable.

Furthermore, if lighting system relies on a single conductor to supply power to be coupled inductively to a lighting network component (e.g., lighting fixture) this will limit how much power can be obtained by a lighting system component through inductive coupling. And an electrical conductor which comes in contact with a metal conduit will no longer be able to provide power in such a system. There are no known arrangements for adequately maintaining a physical separation between an electrical conductor and the conduit in which it runs.

Thus, there is a need in the art to provide a signal carrier having two wires for coupling power, and optionally data, to a lighting network component (e.g., lighting fixture) signal in a contactless manner (e.g., inductively). There is also a need to provide such a signal carrier to which a lighting network component (e.g., lighting fixture) can be coupled easily in the field to receive power, and optionally data, without the need to separate or split wires apart during installation.

### SUMMARY

The present disclosure is directed to inventive lighting systems and an inventive signal carrier for a lighting system. For example, the present invention can provide a signal carrier for supplying power and or communication data to be inductively coupled to a lighting system component such as a lighting fixture, and a lighting system which can employ such a signal carrier.

Generally, in one aspect, a lighting network is provided, comprising: a lighting network base station, a signal carrier, and at least one lighting network component. The lighting network base station has an output configured to provide a radio frequency power signal. The signal carrier comprises: an electrically insulative webbing having a plurality of openings therein, and at least a first electrical conductor and a second electrical conductor separated and spaced apart from each other by the electrically insulative webbing and extending in parallel to each other in a longitudinal direction, the first and second electrical conductors being connected to the output of the lighting network base station. The at least one lighting network component is located remotely from the lighting network base station along the signal carrier and is mounted to the signal carrier at one of the plurality of openings, wherein the at least one lighting network component includes at least one light source and at least one lighting network component coupler configured to extract power from the radio frequency power signal without making an electrically conductive physical contact to the first and second electrical conductors.

In some embodiments, the lighting network base station further includes a power line communication coupler configured to couple the signal carrier to a first power line communication device, wherein the base station power line communication coupler and the at least one lighting network component coupler are configured to communicate network data between the first power line communication device and a second power line communication device via the signal carrier.

In some embodiments, the at least one lighting network component coupler comprises: a power coupler configured to extract the power from the radio frequency power signal without making an electrically conductive physical contact to the first and second electrical conductors; and a lighting network component power line communication coupler, separate from the power coupler, configured to couple the signal carrier to the second power line communication device without making an electrically conductive physical contact to the first and second electrical conductors.

In some embodiments, the lighting network further comprises an impedance termination remotely located from the lighting network base station, wherein the lighting network base station is disposed at a first end of the signal carrier, and wherein the impedance termination is connected across the lighting network line pair at a second end of the signal which is opposite the first end of the lighting network line pair.

In some embodiments, the first and second electrical conductors are disposed within the electrically insulative webbing such that the first and second electrical conductors are not exposed at a location where the at least one lighting network component is mounted to the signal carrier.

In some embodiments, the at least one lighting network component coupler comprises a ferromagnetic coupler at least partially disposed within the one of the plurality of openings where the lighting network component is mounted.

In some embodiments, the lighting network further comprises at least one conduit spacer, wherein at least a portion of the signal carrier is disposed within a metal conduit and is separated and spaced apart from the metal conduit by the at least one conduit spacer.

In some versions of these embodiments, the conduit spacer has a shape of a disk with at least two apertures therethrough, wherein the first and second conductors pass through the two apertures.

In another aspect, a system comprises: a signal carrier and at least one lighting component. The signal carrier comprises: an electrically insulative webbing, and at least a first electrical conductor and a second electrical conductor separated and spaced apart from each other by the electrically insulative webbing and extending in parallel to each other in a longitudinal direction, the first and second electrical conductors being disposed at least partially within the electrically insulative webbing. The at least one lighting component is mounted to the signal carrier, wherein the at least one lighting component includes at least one light source and at least one coupler configured to extract power from the first and second electrical conductors without making an electrically conductive physical contact to the first and second electrical conductors.

In some embodiments, the electrically insulative webbing has a plurality of openings therein, and wherein the at least one lighting component is mounted to the signal carrier at one of the plurality of openings.

In some embodiments, the electrically insulative webbing includes a groove extending in the longitudinal direction between the first and second electrical conductors.

In some embodiments, the electrically insulative webbing has first and second channels extending therethrough in the longitudinal direction, wherein the first and second electrical conductors are disposed, respectively, within the first and second channels.

In some embodiments, the at least one coupler comprises a ferromagnetic coupler at least partially disposed within the one of the plurality of openings where the lighting component is mounted.

In some embodiments, the system further comprises at least one conduit spacer, wherein at least a portion of the signal carrier is disposed within a metal conduit and is separated and spaced apart from the metal conduit by the at least one conduit spacer.

In some versions of these embodiments, the conduit spacer has a shape of a disk with at least two apertures therethrough, wherein the first and second conductors pass through the two apertures.

In some embodiments, the electrically insulative webbing has a plurality of grooves formed therein between the first and second electrical conductors, each of the groves closing upon itself to enclose a defined portion of the webbing.

In still another aspect, a signal carrier comprises: an electrically insulative webbing having at least first and second channels extending therethrough in a longitudinal direction, and at least a first electrical conductor and a second electrical conductor separated and spaced apart from each other by the electrically insulative webbing and extending in parallel to each other in the longitudinal direction, wherein the first and second electrical conductors are disposed, respectively, within the first and second channels.

In some embodiments, the electrically insulative webbing includes a groove extending in the longitudinal direction between the first and second electrical conductors.

In some embodiments, the electrically insulative webbing has a plurality of grooves formed therein between the first and second electrical conductors, each of the grooves closing upon itself to enclose a defined portion of the webbing.

In some embodiments, the electrically insulative webbing has a plurality of openings therein disposed between the first and second channels.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “spectrum” should be understood to refer to any one or more frequencies (or wavelengths) of radiation produced by one or more light sources. Accordingly, the term “spectrum” refers to frequencies (or wavelengths) not only in the visible range, but also frequencies (or wavelengths) in the infrared, ultraviolet, and other areas of the overall electromagnetic spectrum. Also, a given spectrum may have a relatively narrow bandwidth (e.g., a FWHM having essentially few frequency or wavelength components) or a relatively wide bandwidth (several frequency or wavelength components having various relative strengths). It should also be appreciated that a given spectrum may be the result of a mixing of two or more other spectra (e.g., mixing radiation respectively emitted from multiple light sources).

For purposes of this disclosure, the term “color” is used interchangeably with the term “spectrum.” However, the term “color” generally is used to refer primarily to a property of radiation that is perceivable by an observer (although this usage is not intended to limit the scope of this term). Accordingly, the terms “different colors” implicitly refer to multiple spectra having different wavelength components and/or bandwidths. It also should be appreciated that the term “color” may be used in connection with both white and non-white light.

The term “color temperature” generally is used herein in connection with white light, although this usage is not intended to limit the scope of this term. Color temperature essentially refers to a particular color content or shade (e.g., reddish, bluish) of white light. The color temperature of a given radiation sample conventionally is characterized according to the temperature in degrees Kelvin (K) of a black body radiator that radiates essentially the same spectrum as the radiation sample in question. Black body radiator color temperatures generally fall within a range of from approximately 700 degrees K (typically considered the first visible to the human eye) to over 10,000 degrees K; white light generally is perceived at color temperatures above 1500-2000 degrees K.

Lower color temperatures generally indicate white light having a more significant red component or a “warmer feel,” while higher color temperatures generally indicate white light having a more significant blue component or a “cooler feel.” By way of example, fire has a color temperature of approximately 1,800 degrees K, a conventional incandescent bulb has a color temperature of approximately 2848 degrees K, early morning daylight has a color temperature of approximately 3,000 degrees K, and overcast midday skies have a color temperature of approximately 10,000 degrees K. A color image viewed under white light having a color temperature of approximately 3,000 degree K has a relatively reddish tone, whereas the same color image viewed under white light having a color temperature of approximately 10,000 degrees K has a relatively bluish tone.

The term “lighting fixture” is used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

The term “controller” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

The term “addressable” is used herein to refer to a device (e.g., a light source in general, a lighting unit or fixture, a controller or processor associated with one or more light sources or lighting units, other non-lighting related devices, etc.) that is configured to receive information (e.g., data) intended for multiple devices, including itself, and to selectively respond to particular information intended for it. The term “addressable” often is used in connection with a networked environment (or a “network,” discussed further below), in which multiple devices are coupled together via some communications medium or media.

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any functional interconnection of two or more devices (including controllers or processors) that facilitates the transport of information (e.g. for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

The term “user interface” as used herein refers to an interface between a human user or operator and one or more devices that enable communication between the user and the device(s). Examples of user interfaces that may be employed in various implementations of the present disclosure include, but are not limited to, switches, potentiometers, buttons, dials, sliders, a mouse, keyboard, keypad, various types of game controllers (e.g., joysticks), track balls, display screens, various types of graphical user interfaces (GUIs), touch screens, microphones and other types of sensors that may receive some form of human-generated stimulus and generate a signal in response thereto.

The term “contactless” as used herein refers to the absence of an electrically conductive physical contact (e.g., a metallic contact) for passing an electrical signal or power to between a lighting network and a component which is operationally or functionally connected to that lighting network. As used herein, a “contactless connection” refers to an electrical connection which conveys an electrical signal, for example data or power, between a component and a second component (or signal line(s)) without using an electrically conductive (e.g., metal) physical contact. An example of such a contactless connection is an inductive conduction wherein an electrical signal or power is conveyed to or from a component inductively via a coupler such as a transformer or electrical coil.

The term “lighting network component” as used herein refers to a functional component which is operable as part of a lighting network. Examples, without limitation, of a lighting network component include a lighting fixture, a sensor, and a lighting network interface adaptor.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates an example embodiment of a lighting network.

FIG. 2 illustrates an example embodiment of a lighting network component for a lighting network.

FIG. 3 illustrates another example embodiment of a lighting network component for a lighting network.

FIG. 4 illustrates an example embodiment of a signal carrier for a lighting network.

FIG. 5 illustrates a second example embodiment of a signal carrier for a lighting network.

FIG. 6 illustrates a variation of the second example embodiment of a signal carrier for a lighting network.

FIG. 7A illustrates installation of a conduit spacer on an example embodiment of a signal carrier for a lighting network.

FIG. 7B illustrates an installed conduit spacer on an example embodiment of a signal carrier for a lighting network.

FIG. 8 is a first exploded view of the first example embodiment of a lighting network signal carrier and a lighting network component for a lighting network.

FIG. 9 is a second exploded view of the first example embodiment of the lighting network signal carrier and the lighting network component for a lighting network.

FIG. 10 illustrates the first example embodiment of the lighting network signal carrier and a base for the lighting network component to be installed in a lighting network.

FIG. 11 illustrates the first example embodiment of a lighting network signal carrier and the lighting network component for a lighting network.

### DETAILED DESCRIPTION

As discussed above, lighting fixtures which employ physical electrically conductive contacts to receive power and data, and lighting networks in which such lighting fixtures are deployed, are prone to performance degradation and failure due to wear and damage to the physical electrically conductive contacts when the contacts are exposed to contaminants such as moisture, or operate in suboptimal connection conditions, or when the lighting fixtures are inserted or connected to the lighting network over and over again.

More generally, Applicants have recognized and appreciated that it would be beneficial to provide lighting network components (e.g., lighting fixtures), and a lighting network which can allow the lighting network components to be functionally connected to the lighting network without the need for any physical electrically conductive contact between the lighting network components and the power and signal carriers, or lines, of the lighting network.

In view of the foregoing, various embodiments and implementations of the present invention are directed to contactless lighting network components such as a contactless lighting fixture, and a lighting network which employs one or more such contactless lighting network components. Here, it is understood that when the lighting network and lighting network components are referred to as “contactless” this refers to the absence of an electrically conductive physical contact (e.g., a metallic contact) for passing electrical power and/or an electrical signal between the lighting network and lighting network components which are operationally or functionally connected to that lighting network. This does not preclude the possibility that a lighting network component may include some other electrically conductive physical contact to some other external device.

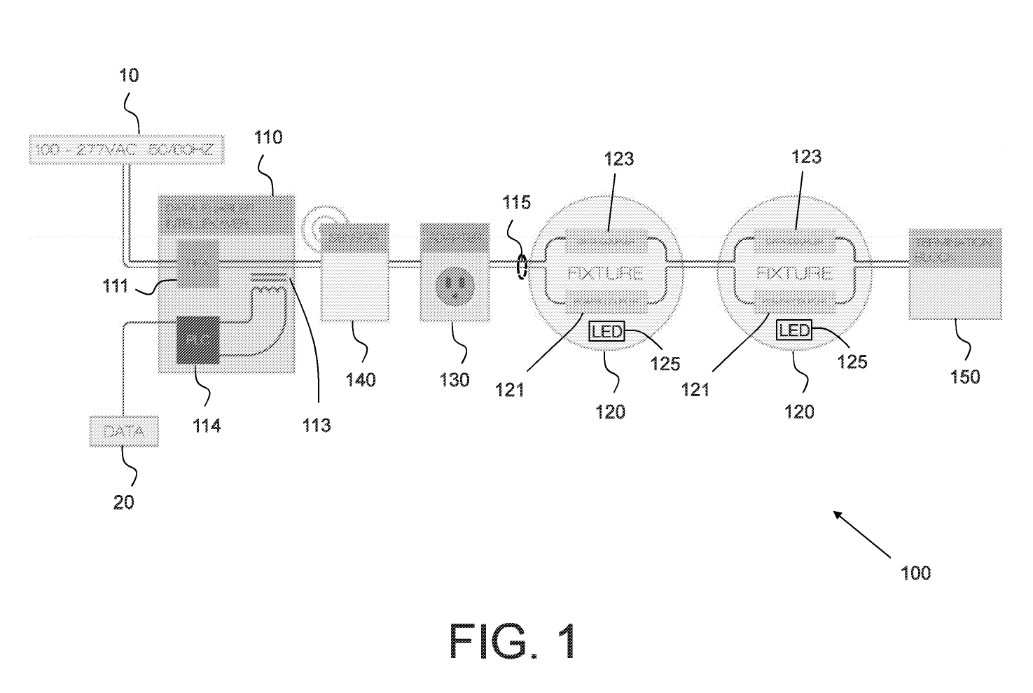

FIG. 1 illustrates an example embodiment of a lighting network 100. Lighting network 100 includes a lighting network base station 110 connected to a plurality of contactless lighting network components via a lighting network line pair 115 which operates as an electrical network signal carrier for conveying power and optionally data to lighting network components of lighting network 100. In lighting network 100 of FIG. 1, the contactless lighting network components include lighting fixtures 120, a lighting network interface adaptor 130, and a lighting sensor module 140. Lighting network 100 may be a light emitting diode (LED) lighting network. As described in greater detail below, line pair 115 may be provided via a signal carrier according to one or more embodiments of the present invention.

Although FIG. 1 illustrates an embodiment of lighting network 100 which includes two lighting fixtures 120, one lighting network interface adaptor 130, and one lighting sensor module 140, it should be understood that in general the lighting network may include any number and combination of contactless lighting network components, limited only by constraints such as the maximum length of the lighting network line pair, the thickness or gauge of the electrical conductors in the lighting network line pair, the power level which can be supplied via the lighting network line pair, the required operating efficiency of the lighting fixtures, the data or communication capabilities of the lighting network line pair, etc.

Also, although FIG. 1 illustrates an embodiment of lighting network 100 which employs a line pair 115, in other embodiments the lighting network could employ any even number of conductors (e.g. 4 conductors, 6 conductors, etc.).

As illustrated in FIG. 1, lighting network base station 110 includes a radio frequency (RF) amplifier 111, a power line communication (PLC) coupler 113, and a power line communication (PLC) device 114. In various embodiments, lighting network base station 110 may include other elements, including for example a controller or processor.

RF amplifier (RFA) 111 is configured to receive AC Mains power from AC Mains 10, to convert the AC Mains power to a radio frequency (RF) power signal, and to supply the radio frequency power signal to lighting network line pair 115.

In some embodiments, AC Mains power may comprise a 50 Hz to 60 Hz at a voltage in a voltage range of 100-277 volts.

RFA 111 may operate to produce an RF power signal in one or more of a variety of frequency ranges in the RF bands, including very low frequencies (VLF—or 3 kHz to 30 kHz), low frequencies (LF—30 kHz to 300 kHz), medium frequencies (MF—300 kHz to 3 MHz); high frequencies (HF—3 MHz to 30 MHz) or higher frequency ranges in the RF bands. However, in particular it is understood that RF amplifier 111 and the RF power signal do not operate in optical frequency bands such as infrared, visible, or ultraviolet bands. In some embodiments, RFA 111 may output an RF power signal having a frequency of about 20 kHz and a voltage level of 260 VAC at the output of lighting network base station 110. In some embodiments, RFA 111 may have an output power level of 1 kilowatt. However, it is understood that other voltage levels, power levels, and frequencies may be employed in lighting network 100, and these numbers are only provided to illustrate a concrete embodiment.

PLC device 114 is configured to communicate with an external data communication device 20 to exchange data therewith (i.e., to receive data therefrom and/or to transmit data thereto). In general, data received from external data communication device 20 may be received in a variety of formats, including for example, Ethernet, DMX, DALI, wireless and analog formats (e.g., an analog dimming signal), etc. In that case, beneficially PLC device 114 may be configured to convert the received data into network data which is communicated by lighting network base station 110 to one or more lighting network components (e.g., one or more lighting fixtures 120 and/or one or more lighting network interface adaptors 130) via lighting network line pair 115. In some embodiments, external data communication device 20 may comprise a computer, a user interface, a wireless receiver, a connection to another lighting network, etc. In some embodiments, lighting network base station 110 may include a controller or processor which may operate in conjunction with PLC device 114 to convert data between a data format (e.g., an Ethernet packet) for a power line communication (PLC) signal for communicating the data via lighting network line pair 115, and other various data formats, for example Ethernet, DMX, DALI, wireless and analog formats (e.g., an analog dimming signal), etc. In some embodiments external data communication device 20 and/or a processor of lighting network base station 110 may execute one or more software algorithms to operate as a lighting controller for lighting network 100, controlling operations of the one or more lighting fixtures 120 of lighting network 100. Examples of such operations will be described below.

PLC coupler 113 is configured to couple PLC device 114 to lighting network line pair 115. PLC coupler 113 may be an inductive coupler which couples PLC device 114 to lighting network line pair 115 without making an electrically conductive physical contact to lighting network line pair 115. In various embodiments, PLC coupler 113 may comprise an inductor, transformer, or electrical coil. In some embodiments, PLC coupler 113 is configured to couple a PLC signal from PLC device 114 onto lighting network line pair 115 whereby the PLC signal carries network data, for example lighting data for controlling one or more operating parameters of one or more light sources (e.g., LED-based light sources) of one of more lighting fixtures 120.

The PLC signal may operate in one or more of a variety of frequency ranges in the RF bands, but does not operate in optical frequency bands such as infrared, visible, or ultraviolet bands. In that case, it is seen that PLC coupler 113 is not an optocoupler. In some embodiments, the PLC signal may operate on lighting network line pair 115 at one or more frequencies in a frequency range of 2-68 MHz In some embodiments, the PLC signal may comprise an Ethernet signal. In some embodiments, the PLC signal may communicate data over the lighting network line pair 115 at a data rate of about 200 Mbps.

Lighting network line pair 115 comprises a pair of electrically conductive wires and may operate as a transmission line with characteristic impedance at the operating frequency(s) of the RF power signal and PLC signal in the RF frequency bands. In some embodiments, the output impedance of RFA 111 may be selected to operate with the characteristic impedance of lighting network line pair 115. In that case, termination block 150 may be selected to have an impedance which is matched to the output impedance of RFA 111. In some embodiments, termination block 150 may be omitted, which may result in degraded performance of lighting network 100, for example reduced efficiency. In some embodiments, lighting network 100 may employ other lines, wires, or signal carriers in addition to lighting network line pair 115.

Lighting fixture 120 includes a power coupler 121, a power line communication (PLC) coupler 123, and a lighting emitting diode (LED) based lighting unit 125. In various embodiments, lighting fixture 120 may also include a lighting driver, a controller, one or more sensors, and a second power line communication device which communicates with PLC device 114 via power line communication (PLC) coupler 123 and lighting network line pair 115.

Power coupler 121 may be an inductive coupler, and is configured to extract electrical power from the RF power signal on lighting network line pair 115 without making an electrically conductive physical contact to lighting network line pair 115. In various embodiments, power coupler 121 may comprise an inductor, transformer, or electrical coil. As noted above, the RF power signal operates in one or more of a variety of frequency ranges in the RF bands, but is not an optical signal operating in an optical band. In that case, it is seen that power coupler 121 is not an optocoupler.

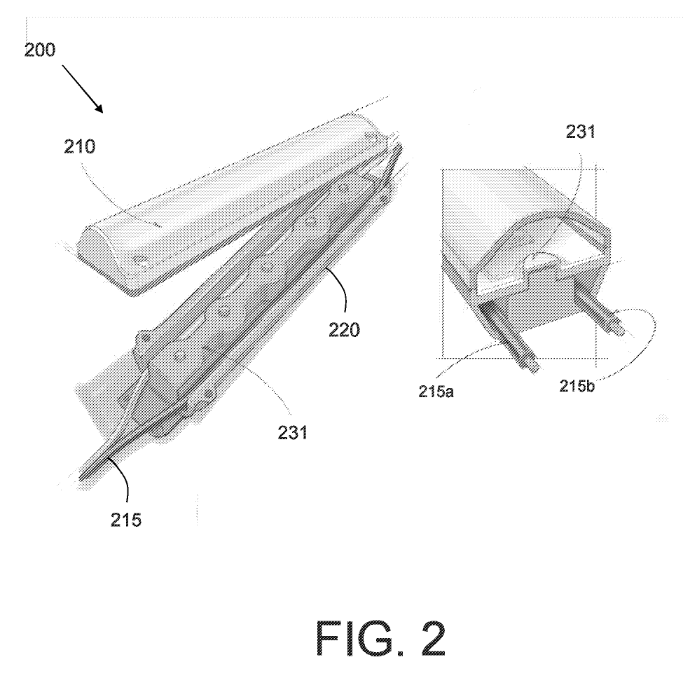

FIG. 2 illustrates an example embodiment of a lighting network component 200 for a lighting network. Lighting network component 200 may comprise a cove lighting fixture, and includes a base 220 and cover 210. Base 220 is configured to receive a line pair 215, and to separate the two lines 215a and 215b along either side thereof. Between the two lines within base 220 are disposed one or more inductive couplers 231 for coupling data and power to lighting network component 200.

Lighting network component 200 may be referred to as a contactless lighting network component as it is configured to be operationally or functionally connected to a lighting network via line pair 215 without having any an electrically conductive physical contact (e.g., a metallic contact) to line pair 215 for passing an electrical signal or power to between line pair 215 and lighting network component 200.

However, in the arrangement shown in FIG. 2, the two electrical conductors of line pair 215 must be separated from each other at the place where lighting network component 200 is coupled to line pair 215. In addition to the labor required for such an installation, this presents a possibility that the either or both of the wires of line pair 214 can expose bare metal (e.g., copper) carrying a live current when the two wires are separated from each other. Factory-split cable or cord with the two wires for the line pair 215 split apart at predetermined positions could be manufactured, but this does not offer any flexibility to the end user as far as where lighting network component 200 is positioned to be connected to line pair 215.

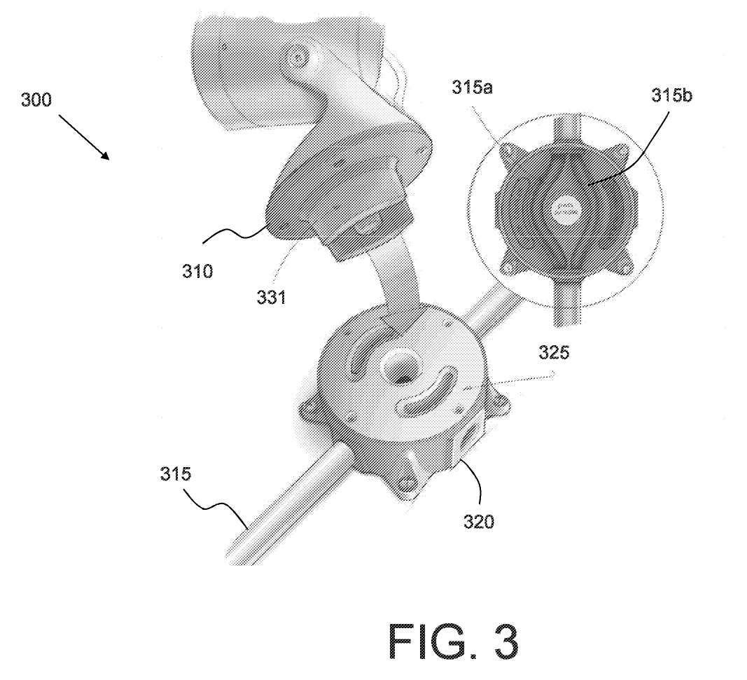

FIG. 3 illustrates another example embodiment of a lighting network component 300 for a lighting network. Lighting network component 300 comprises a base 320 and housing 310. Base 320 is configured to receive a line pair via a cable 315, and to separate the two lines 315a and 315b along either side thereof. Housing 310 may be removably attached to base 320 in such a way as to provide two inductive couplers 331 adjacent to lines 315a and 315b for coupling data and power to lighting network component 300. Although lighting network component 300 employs a separate power coupler 331 and PLC coupler 331, in some embodiments it may be possible to employ a single inductive coupler and to separate power and data signals at the output of the single inductive coupler, as described above.

Lighting network component 300 may be referred to as a contactless lighting network component as it is configured to be operationally or functionally connected to a lighting network via cable 315 without having any an electrically conductive physical contact (e.g., a metallic contact) to lines 315a and 315b for passing an electrical signal or power to between cable 315 and lighting network component 300.

However, in the arrangement shown in FIG. 3, as with the arrangement shown in FIG. 2, the two electrical conductors of cable 315 must be separated from each other at the place where base 320 is coupled to cable 315. In addition to the labor required for such an installation, this presents a possibility that either or both of the wires 315a and 315b can expose bare metal (e.g., copper) carrying a live current when the two wires are separated from each other. Cable 315 could be manufactured at a factory with the wires 315a and 315b already split apart from each other at predetermined positions, but this does not offer any flexibility to the end user as far as where lighting network component 300 is positioned to be connected to cable 315.

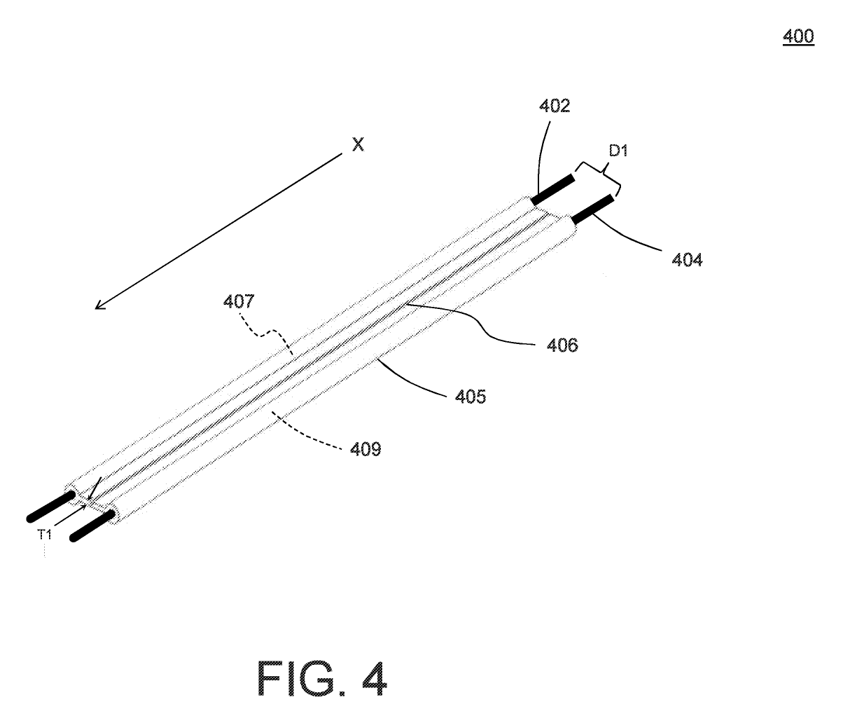

FIG. 4 illustrates an example embodiment of a signal carrier 400 for a lighting network, such as lighting network 100 of FIG. 1. Lighting network signal carrier 400 may be one embodiment of lighting network line pair 115 in lighting network 100. In a lighting network such as lighting network 100, one or more lighting network components (e.g., lighting fixtures) may be coupled to lighting network signal carrier 400 to receive power, and optionally data, therefrom as described above with respect to FIG. 1.

Lighting network signal carrier 400 includes first and second electrical conductors (wires) 402 and 404 which are separated and spaced apart from each other at a spacing D1 by an electrically insulative webbing 405 and which extend in parallel to each other in a longitudinal direction X. In some embodiments, D1 may be in a range of 20-26 mm, for example about 24 mm. Of course other beneficial spacings may be employed in other embodiments. Beneficially, electrically insulative webbing 405 includes first and second channels 407 and 409 extending therethrough in the longitudinal direction X from a first end to a second end thereof. First and second electrical conductors (wires) 402 and 404 are disposed, respectively, in first and second channels 407 and 409 such that includes first and second electrical conductors (wires) 402 and 404 are disposed within electrically insulative webbing 405. Beneficially, first and second electrical conductors (wires) 402 and 404 may only be exposed at the opposite ends of electrically insulative webbing 405 in the longitudinal direction X.

Electrically insulative webbing 405 has a thickness T1 in a region between first and second channels 407 and 409. In some embodiments, T1 may be about 2 mm.

Electrically insulative webbing 405 also has a groove 406 provided therein extending in the longitudinal direction X between the first and second electrical conductors 403 and 404 disposed in first and second channels 407 and 409, wherein the thickness of electrically insulative webbing 405 is reduced in the area of groove 406. Groove 406 may facilitate a controlled separation of first and second electrical conductors 403 and 404 during field installation of lighting network signal carrier 400 with one or more lighting network components (e.g., lighting fixtures), to inhibit the possibility of one or both of first and second electrical conductors 403 and 404 being exposed inadvertently when first and second electrical conductors 403 and 404 are separated or split apart from each other.

Electrically insulative webbing 405 may comprise or consist of plastic, rubber, fabric, ceramic, or other suitable electrically insulative material.

Although FIG. 4 illustrates an embodiment of a lighting network signal carrier which employs two conductors, in other embodiments the lighting network signal carrier could employ any even number of conductors (e.g. 4 conductors, 6 conductors, etc.). Also, although in FIG. 4 the spacing between groove 406 and first and second electrical conductors 403 and 404 is the same, this is not required.

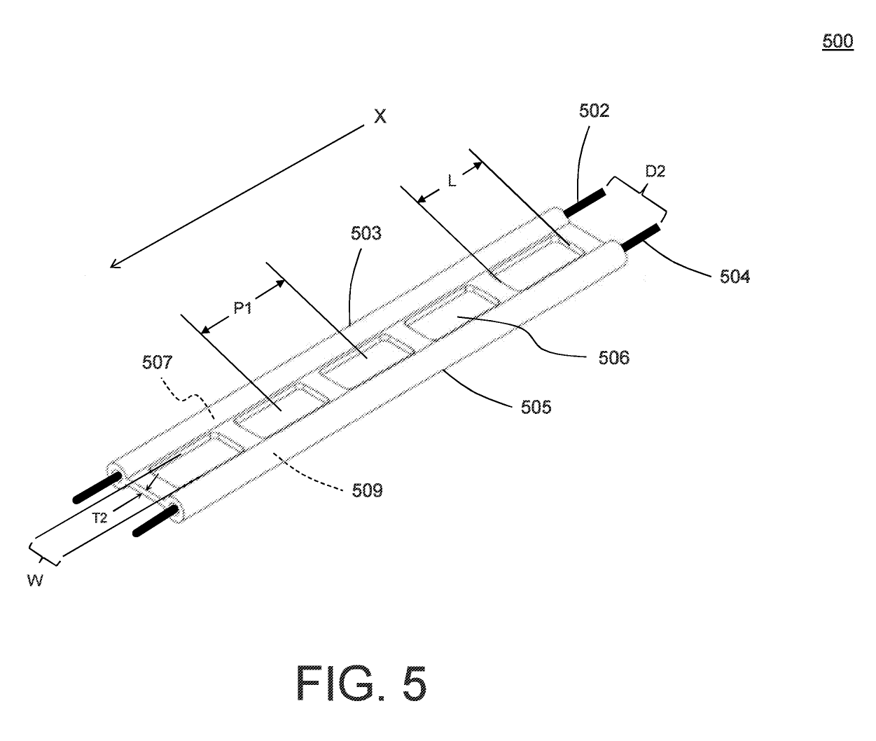

FIG. 5 illustrates a second example embodiment of a signal carrier 500 for a lighting network, such as lighting network 100 of FIG. 1. Lighting network signal carrier 500 may be one embodiment of lighting network line pair 115 in lighting network 100. In a lighting network such as lighting network 100, one or more lighting network components (e.g., lighting fixtures) may be coupled to lighting network signal carrier 500 to receive power, and optionally data, therefrom as described above with respect to FIG. 1.

Lighting network signal carrier 500 includes first and second electrical conductors (wires) 502 and 504 which are separated and spaced apart from each other at a spacing D2 by an electrically insulative webbing 505 and which extend in parallel to each other in a longitudinal direction X. In some embodiments, D1 may be in a range of 20-26 mm, for example about 24 mm. Beneficially, electrically insulative webbing 505 includes first and second channels 507 and 509 extending therethrough in the longitudinal direction X from a first end to a second end thereof. First and second electrical conductors (wires) 502 and 504 are disposed, respectively, in first and second channels 507 and 509 such that includes first and second electrical conductors (wires) 502 and 504 are disposed within electrically insulative webbing 505. Beneficially, first and second electrical conductors (wires) 502 and 504 may only be exposed at the opposite ends of electrically insulative webbing 505 in the longitudinal direction X.

Electrically insulative webbing 505 has a thickness T2 in a region between first and second channels 507 and 509. In some embodiments, T2 may be about 2 mm. Electrically insulative webbing 505 may comprise or consist of plastic, rubber, fabric, ceramic, or other suitable electrically insulative material.

Electrically insulative webbing 505 also has provided therein a plurality of openings 506 aligned adjacent each other in the longitudinal direction X between the first and second electrical conductors 503 and 504 disposed in first and second channels 507 and 509. As explained in greater detail below one or more lighting network components (e.g., lighting fixtures) may be mounted on signal carrier 500 at openings 506, which are also referred to herein as attachment slots 506. As explained in greater detail below, this arrangement may facilitate the coupling of power, and optionally data, from lighting network signal carrier 500 to one or more lighting network components (e.g., lighting fixtures) without a need for separation of first and second electrical conductors 502 and 504 from each other during field installation, thus inhibiting the possibility of one or both of first and second electrical conductors 503 and 504 being exposed inadvertently at the location(s) where the lighting network component(s) is/are mounted to lighting network signal carrier 500. In some embodiments, lighting network components (e.g., lighting fixtures) which are mounted onto lighting network signal carrier 500 include ferrite coupling components which are required to make contact with each other and not have any electrically insulative webbing 505 between them. In that case, slots 506 allow these lighting network components to be easily mounted to lighting network signal carrier 500. In particular, a lighting network components (e.g., a lighting fixture) may be mounted to lighting network signal carrier 500 at any attachment slot 506 without cutting or otherwise disassembling or altering lighting network signal carrier 500 in any way. This may increase the ease, reliability, and flexibility of attaching lighting network components to lighting network signal carrier 500. One or more ferrite core couplers may be employed by the lighting network component to extract power, and optionally data, from lighting network signal carrier 500. Beneficially, the use of two electrical conductors 502 and 504 may offer the ability to provide increased power to the lighting network component, compared to use of a single wire. Additionally, multiple ferrite cores may be employed by one lighting network component where necessary to provide even greater power to the lighting network component.

In some embodiments, the length L of each opening or attachment slot 506 may be about 35 mm, the width W of each opening or attachment slot 506 may be about 12 mm, and the pitch P between the openings or attachment slots 506 may be about 32 mm. Of course other beneficial dimensions may be employed in other embodiments.

Although FIG. 5 illustrates an embodiment of a lighting network signal carrier which employs two conductors, in other embodiments the lighting network signal carrier could employ any even number of conductors (e.g. 4 conductors, 6 conductors, etc.). Also, although in FIG. 5 the spacing between slots 506 is uniform, this is not required. Similarly, the slots 506 do not have to be centered or equally spaced between electrical conductors 502 and 504.

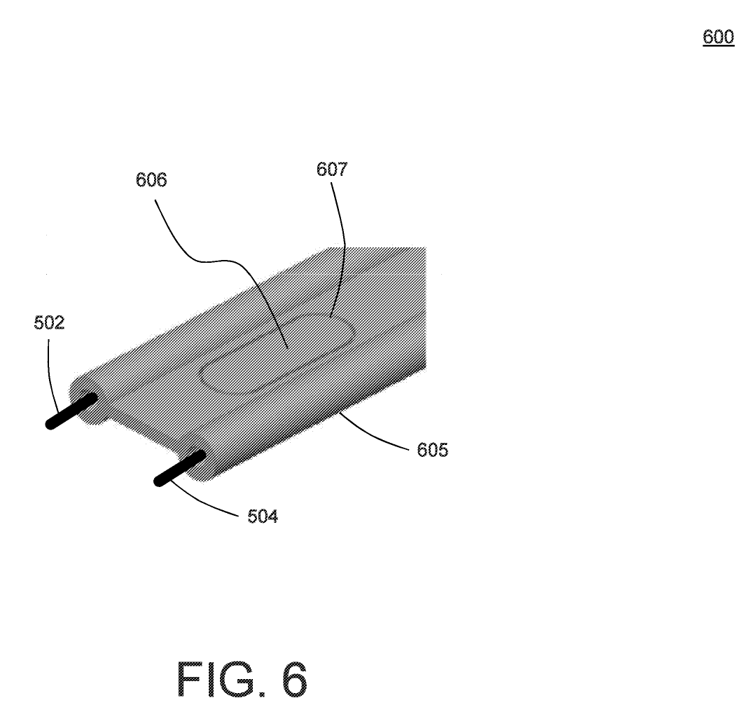

FIG. 6 illustrates a variation 600 of the second example embodiment of a signal carrier for a lighting network, such as lighting network 100 of FIG. 1. Lighting network signal carrier 600 may be one embodiment of lighting network line pair 115 in lighting network 100. In a lighting network such as lighting network 100, one or more lighting network components (e.g., lighting fixtures) may be coupled to lighting network signal carrier 600 to receive power, and optionally data, therefrom as described above with respect to FIG. 1.

Lighting network signal carrier 600 is similar to lighting network signal carrier 500 such that only differences therebetween will be described. The webbing 605 of lighting network signal carrier 600 has a plurality of grooves 607 formed therein between first and second electrical conductors 502 and 504, each of the grooves 607 closing upon itself to enclose a portion 606 of the webbing. During installation, any or all of the portions 606 may be punched out by an installer to produce one or more opening or attachment slots such as the opening or attachment slot 506 of lighting network signal carrier 500. For example, an installer may punch through a portion 606 to produce an opening or attachment slot wherever the installer wants to mount a lighting network component (e.g., lighting fixture). In some embodiments, grooves 607 may be perforated along the length of lighting network signal carrier 600, allowing the installer to “rip” a slot 506 open for the installation.

Beneficially, lighting network signal carriers 500 and 600 lend themselves to the use of conduit spacers or clips for facilitating the installation or routing of the lighting network signal carrier in a metal conduit while mitigating the possibility of any of the electrical conductors 502 or 504 inadvertently coming into contact with the metal conduit and thereby preventing the lighting network signal carrier from conveying power to lighting network components.

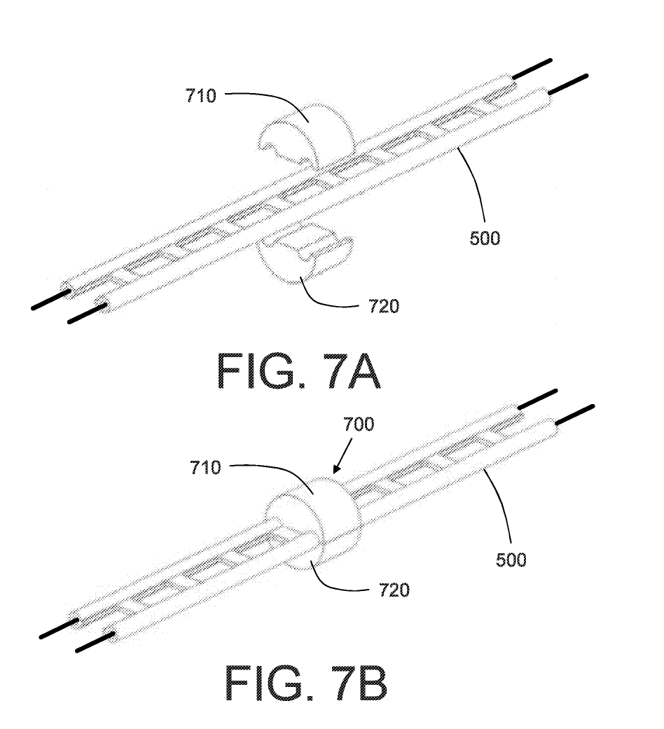

FIG. 7A illustrates installation of a conduit spacer or clip 700 onto an example embodiment of a signal carrier 500 for a lighting network. Here it is seen that conduit spacer 700 includes first and second spacer portions 710 and 720 which are placed on opposite sides of signal carrier 500 and then connected (e.g., snapped) together to form a disk-shaped conduit spacer 700.

FIG. 7B illustrates an installed conduit spacer 700 on an example embodiment of a signal carrier 500 for a lighting network. The disk shaped conduit spacer 700 has at least two apertures therethrough such that first and second conductors 502 and 504 pass through the two apertures. In some embodiments, conduit spacer 700 may include a third aperture for a portion of electrically insulative webbing 505 to pass therethrough.

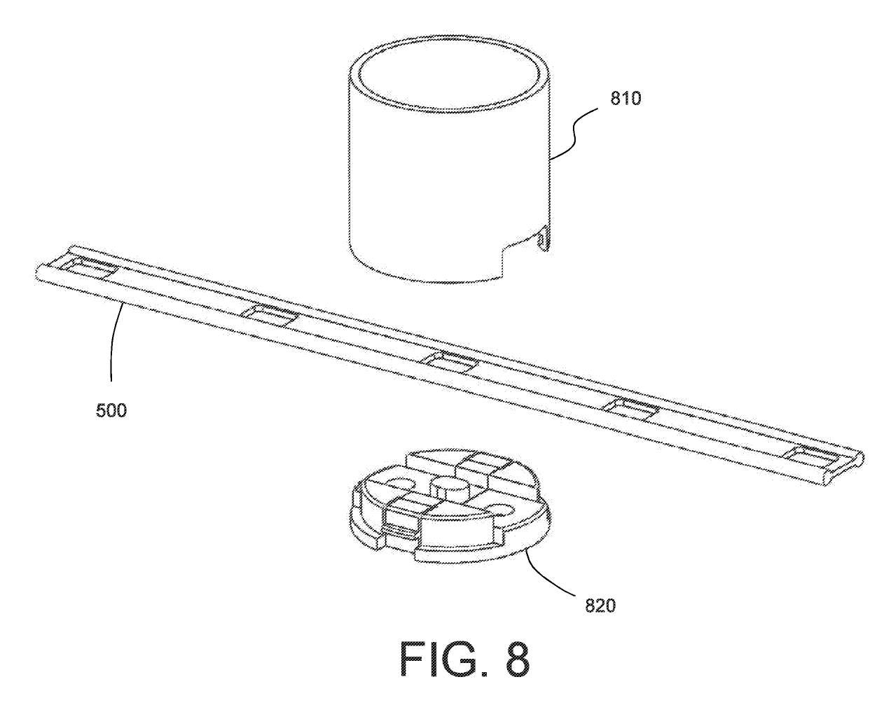

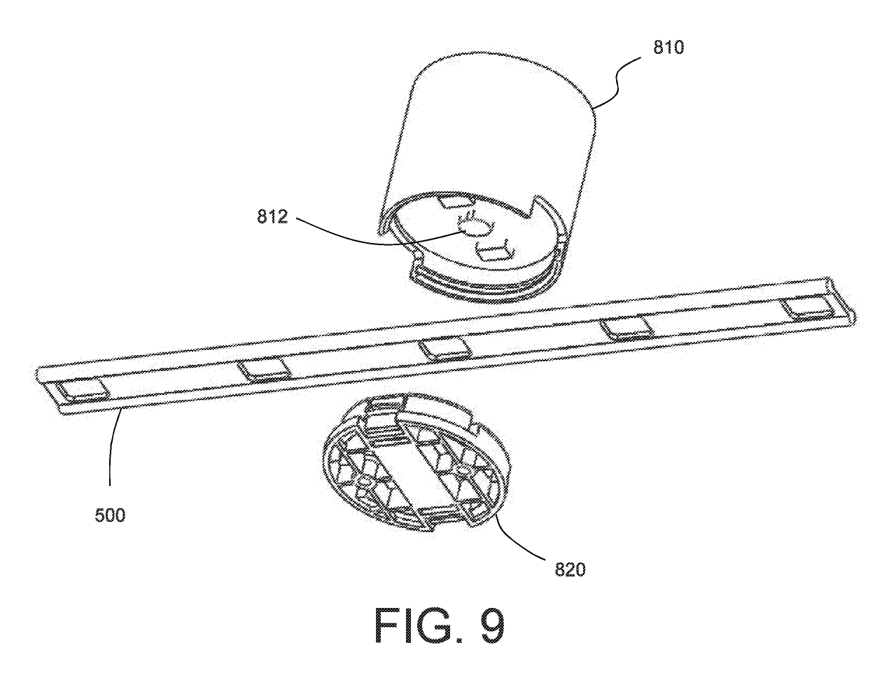

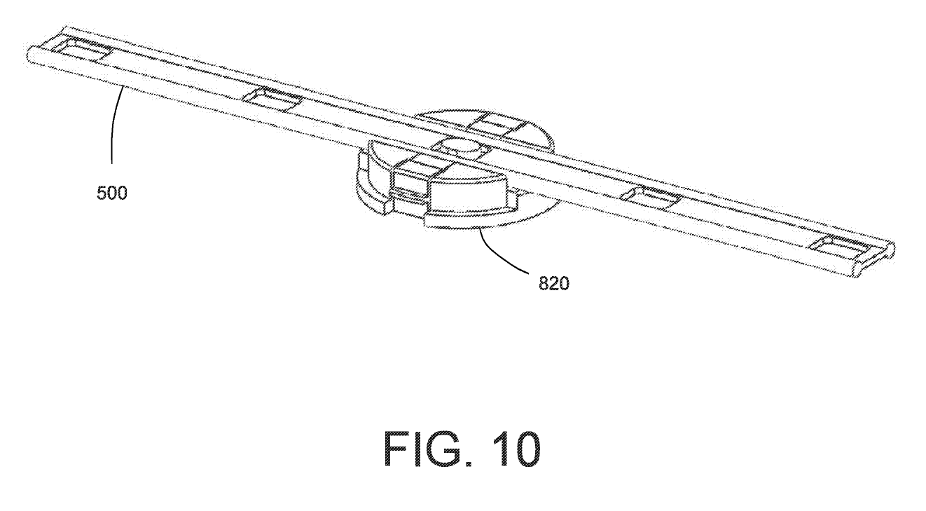

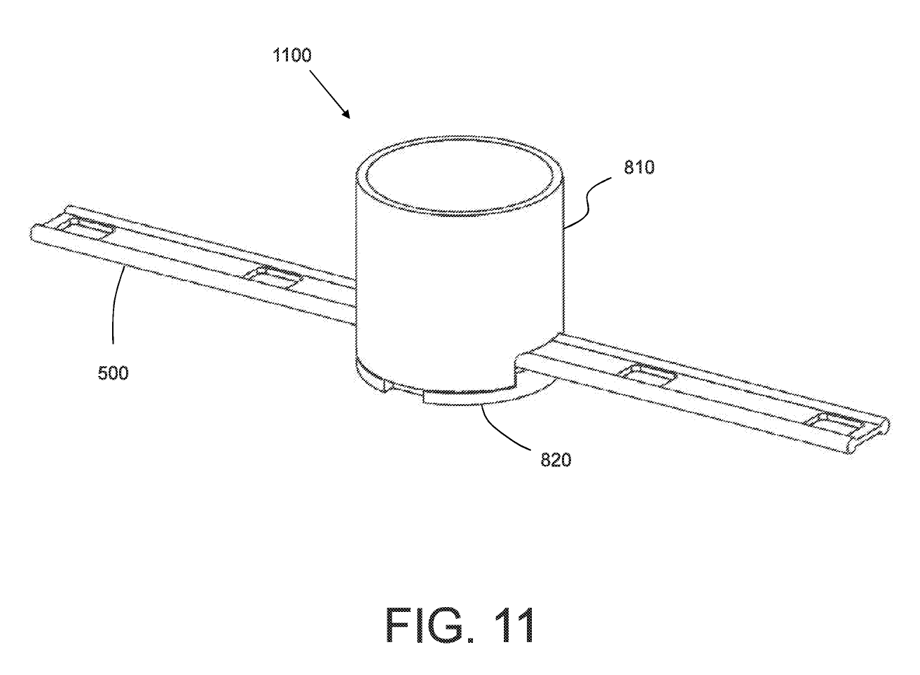

FIG. 8 is a first exploded view of the first example embodiment of lighting network signal carrier 500 and a lighting network component for a lighting network. FIG. 9 is a second exploded view of the first example embodiment of lighting network signal carrier 500 and the lighting network component for a lighting network. FIG. 10 illustrates the first example embodiment of lighting network signal carrier 500 and base 820 for the lighting network component to be installed in a lighting network. FIG. 11 illustrates the first example embodiment of lighting network signal carrier 500 and the lighting network component 1100 for a lighting network.

Lighting network component 1100 may be referred to as a contactless lighting network component as it is configured to be operationally or functionally connected to a lighting network via lighting network signal carrier 500 without having any an electrically conductive physical contact (e.g., a metallic contact) to first and second electrical conductors 502 or 504 for passing an electrical signal or power to between lighting network signal carrier 500 and lighting network component 1100.

As illustrated in FIGS. 8-11, lighting network component 1100 includes a housing 810 and a base 820. Housing 810 include a coupler 812 (e.g., a ferrite coupler) for coupling power, and optionally data, from lighting network signal carrier 500 As illustrated in FIG. 10, base 820 is attached to lighting network signal carrier 500 at any one of a plurality of selected locations which are defined by attachment slots 506 in lighting network signal carrier 500. Housing 810 may then be attached to base 820 such that ferrite coupler 812 may be at least partially disposed within the one of the plurality of openings 506 in electrically insulative webbing 505 s that lighting network component 1100 may receive power from, and communicate network data with, first and second electrical conductors 502 and 504 of lighting network signal carrier 500, without making any electrically conductive physical contact to first or second electrical conductor 502 or 504. In particular, as described above, lighting network component 1100 may inductively couple to first and second electrical conductors 502 and 504 via coupler 812 to receive power therefrom, and communicate network data therewith.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A lighting network, comprising:
a lighting network base station having an output configured to provide a radio frequency power signal;
a signal carrier, comprising,
an electrically insulative webbing having a plurality of openings therein, and
at least a first electrical conductor and a second electrical conductor separated and spaced apart from each other by the electrically insulative webbing and extending in parallel to each other in a longitudinal direction, the first and second electrical conductors being connected to the output of the lighting network base station; and
at least one lighting network component located remotely from the lighting network base station along the signal carrier and mounted to the signal carrier at one of the plurality of openings, wherein the at least one lighting network component includes at least one light source and at least one lighting network component coupler configured to extract power from the radio frequency power signal without making an electrically conductive physical contact to the first and second electrical conductors, and
an impedance termination remotely located from the lighting network base station, wherein the lighting network base station is disposed at a first end of the signal carrier, and wherein the impedance termination is connected across the lighting network line pair at a second end of the signal which is opposite the first end of the lighting network line pair.

2. The lighting network of claim 1, wherein the lighting network base station further includes a power line communication coupler configured to couple the signal carrier to a first power line communication device, wherein the base station power line communication coupler and the at least one lighting network component coupler are configured to communicate network data between the first power line communication device and a second power line communication device via the signal carrier.

3. The lighting network of claim 1, wherein the at least one lighting network component coupler comprises:
a power coupler configured to extract the power from the radio frequency power signal without making an electrically conductive physical contact to the first and second electrical conductors; and
a lighting network component power line communication coupler, separate from the power coupler, configured to couple the signal carrier to the second power line communication device without making an electrically conductive physical contact to the first and second electrical conductors.

4. (canceled)

5. The lighting network of claim 1, wherein the first and second electrical conductors are disposed within the electrically insulative webbing such that the first and second electrical conductors are not exposed at a location where the at least one lighting network component is mounted to the signal carrier.

6. The lighting network of claim 1, wherein the at least one lighting network component coupler comprises a ferromagnetic coupler at least partially disposed within the one of the plurality of openings where the lighting network component is mounted.

7. The lighting network of claim 1, further comprising at least one conduit spacer, wherein at least a portion of the signal carrier is disposed within a metal conduit and is separated and spaced apart from the metal conduit by the at least one conduit spacer.

8. The lighting network of claim 7, wherein the conduit spacer has a shape of a disk with at least two apertures therethrough, wherein the first and second conductors pass through the two apertures.

9. A system, comprising:
a signal carrier, comprising,
an electrically insulative webbing, and
at least a first electrical conductor and a second electrical conductor separated and spaced apart from each other by the electrically insulative webbing and extending in parallel to each other in a longitudinal direction, the first and second electrical conductors being disposed at least partially within the electrically insulative webbing; and
at least one lighting component mounted to the signal carrier, wherein the at least one lighting component includes at least one light source and at least one coupler configured to extract power from the first and second electrical conductors without making an electrically conductive physical contact to the first and second electrical conductors, and
an impedance termination, wherein a lighting network base station is disposed at a first end of the signal carrier, and wherein the impedance termination is connected across a lighting network line pair at a second end of the signal carrier which is opposite the first end of the lighting network line pair.

10. The system of claim 9, wherein the electrically insulative webbing has a plurality of openings therein, and wherein the at least one lighting component is mounted to the signal carrier at one of the plurality of openings.

11. The system of claim 9, wherein the electrically insulative webbing includes a groove extending in the longitudinal direction between the first and second electrical conductors.

12. The system of claim 9, wherein the electrically insulative webbing has first and second channels extending therethrough in the longitudinal direction, wherein the first and second electrical conductors are disposed, respectively, within the first and second channels.

13. The system of claim 9, wherein the at least one coupler comprises a ferromagnetic coupler at least partially disposed within the one of the plurality of openings where the lighting component is mounted.

14. The system of claim 9, further comprising at least one conduit spacer, wherein at least a portion of the signal carrier is disposed within a metal conduit and is separated and spaced apart from the metal conduit by the at least one conduit spacer.

15. The system of claim 14, wherein the conduit spacer has a shape of a disk with at least two apertures therethrough, wherein the first and second conductors pass through the two apertures.

16. The system of claim 9, wherein the electrically insulative webbing has a plurality of grooves formed therein between the first and second electrical conductors, each of the grooves closing upon itself to enclose a defined portion of the webbing.

17. A signal carrier, comprising:
an electrically insulative webbing having at least first and second channels extending therethrough in a longitudinal direction, and
at least a first electrical conductor and a second electrical conductor separated and spaced apart from each other by the electrically insulative webbing and extending in parallel to each other in the longitudinal direction, wherein the first and second electrical conductors are disposed, respectively, within the first and second channels,
wherein the electrically insulative webbing has a plurality of grooves formed therein between the first and second electrical conductors, each of the grooves closing upon itself to enclose a defined portion of the webbing.

18. The signal carrier of claim 17, wherein the electrically insulative webbing includes a groove extending in the longitudinal direction between the first and second electrical conductors.

19. (canceled)

20. The signal carrier of claim 17, wherein the electrically insulative webbing has a plurality of openings therein disposed between the first and second channels.
